(19) United States
(12) Patent Application Publication
(10) Pub. No.: US 2025/0276671 A1
(43) Pub. Date: Sep. 4, 2025

(54) WIPER BLADE DEVICE INCLUDING IMPROVED STRUCTURE FOR PREVENTING SEPARATION OF SPOILER

(71) Applicant: DY AUTO CORPORATION, Asan-si (KR)

(72) Inventors: Sang Kweon LEE, Asan-si (KR); Jeong Byung LEE, Asan-si (KR)

(21) Appl. No.: 18/968,591

(22) Filed: Dec. 4, 2024

(30) Foreign Application Priority Data
Feb. 29, 2024 (KR) 10-2024-0030003

(51) Int. Cl. B60S 1/38

(52) U.S. Cl. CPC B60S 1/381; B60S 2001/3817

(57) ABSTRACT

A wiper blade device includes a support member, a spoiler member including a support member accommodating portion, a wiper lip accommodating portion, and a spoiler portion, wherein the support member accommodating portion is shapes as a tunnel, the wiper lip accommodating portion has a wiper lip coupled thereto, and a spoiler portion configured to generate pressure downwardly by flow of air, a wiper lip that is coupled to the wiper lip accommodating portion, and a connector disposed on a central portion of the support member and fixed to the spoiler member, in which the connector includes a spoiler fixing portion in a form of a groove open downward, the spoiler fixing portion includes a first claw and a second claw that support the spoiler member in a height direction of the wiper lip to prevent the spoiler member from being separated downward from the connector.

### CROSS-REFERENCE TO RELATED APPLICATION

This application is based on and claims priority under 35 U.S.C. § 119 to Korean Patent Application No. 10-2024-0030003, filed on Feb. 29, 2024, in the Korean Intellectual Property Office, the disclosure of which is incorporated by reference herein in its entirety.

### BACKGROUND

### 1. Field

The disclosure relates to a wiper blade device, and more particularly, to a coupling structure between a spoiler and a connector of a wider blade device.

### 2. Description of the Related Art

A wiper device of a vehicle removes foreign substances from a front or rear windshield of the vehicle. The wiper device is an important device that enables safe driving by ensuring a driver's field of vision. The wiper device may include a motor, a link structure, a wiper arm, and a wiper blade. Among these components, a wiper blade device removes foreign substances in direct contact with the glass. Recently, as a frame of the wiper blade, a wiper blade using a single frame in the shape of a thin and long bar bent with a predetermined curvature has been used. In the art, such a wiper blade is known as a flat wiper blade or a flat-bar wiper blade.

Generally, a flat wiper blade device includes a connector detachably connected to a wiper arm, a spoiler coupled to the connector to facilitate airflow, a support member (vertebra) providing an elastic restoring force to the spoiler, and a wiper lip coupled to the spoiler to remove foreign substances from the glass.

For example, the support member may be coupled to the spoiler through a sliding structure. The wiper lip may be removably coupled to the spoiler in a sliding manner. A cap may be inserted into opposite ends of the spoiler. The connector may be formed by coupling of a plurality of members. The spoiler may be divided into opposite sides with respect to the center of the connector. The spoiler may be slidably coupled to the connector.

However, when a spoiler and a connector in a wiper blade device in the art are coupled to each other, application of an unexpected force may cause the spoiler to become detached from the connector. When the spoiler is detached from the connector while the wiper blade device is mounted on the vehicle, normal operation of the wiper may be impossible, causing a serious risk to safe driving of the vehicle.

### SUMMARY

Provided is a wiper blade device with an improved structure of a connector to prevent a spoiler from leaving the connector unexpectedly.

Additional aspects will be set forth in part in the description which follows and, in part, will be apparent from the description, or may be learned by practice of the presented embodiments of the present disclosure.

According to an aspect of the disclosure, a wiper blade device having an improved structure for preventing separation of a spoiler includes a support member formed longitudinally in a form of a metal-plate shaped rod, a spoiler member including a support member accommodating portion, a wiper lip accommodating portion at a bottom portion thereof, and a spoiler portion at a top end portion thereof, wherein the support member accommodating portion is shaped as a tunnel to which the support member is coupled, the wiper lip accommodating portion has a wiper lip slidably coupled thereto, and a spoiler portion configured to generate pressure downwardly by flow of air, a wiper lip which is coupled to the wiper lip accommodating portion and comes into contact with glass of a vehicle to remove foreign substances, and a connector disposed on a central portion of the support member, fixed to the spoiler member, and coupled to a wiper arm, in which the connector includes a spoiler fixing portion in a form of a groove open downward to enable coupling of the spoiler member, the spoiler fixing portion includes a first claw and a second claw that support the spoiler member in a height direction of the wiper lip to prevent the spoiler member from being separated downward from the connector, the second claw is disposed under the first claw in a height direction of the wiper lip, and the second claw supports the spoiler member closer to a center of the wiper lip than the first claw.

The second claw may include a structure in a shape of a cantilever protruding from the connector toward the wiper lip.

The second claw may not contact the wiper lip.

The second claw may support the spoiler member in a region closer to a center of the wiper lip than the first claw.

The second claw may have a smaller area in contact with the spoiler member than the first claw.

The second claw may form a lowermost portion of the connector.

The spoiler member may not include the spoiler portion in a region coupled to the connector.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a wiper blade device according to an embodiment;

FIG. 2 is an exploded perspective view of the wiper blade device shown in FIG. 1;

FIG. 3 is a cross-sectional view of the wiper blade device taken along a line III-III shown in FIG. 1; and

FIG. 4 is a view showing in detail a lower structure of a connector shown in FIG. 2.

### DETAILED DESCRIPTION

Reference will now be made in detail to embodiments, examples of which are illustrated in the accompanying drawings, wherein like reference numerals refer to like elements throughout. In this regard, the current embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments of the disclosure will be described in detail with reference to the accompanying drawings. The terms and words used in the present specification and claims described above should not be construed as being limited to ordinary or dictionary meanings, and should be interpreted as meanings and concepts consistent with the technical idea of the disclosure based on the principle that the present inventors may appropriately define the concept of the terms to describe their invention in the best way. Therefore, it should be understood that the configurations shown in the drawings and embodiments described in this specification are merely the most preferred embodiments of the disclosure, and do not represent all of the technical ideas of the disclosure, such that there may be various equivalents and variations that replace them at the time of filing the present application. If used herein, “comprise, include” and/or “comprising, including” specify mentioned shapes, numbers, steps, operations, members, components, and/or presence of these groups, and do not exclude the presence or addition of one or more different shapes, numbers, operations, members, components, and/or groups. If embodiments of the disclosure are described, “can” or “may” may include “one or more embodiments of the disclosure”.

To help understanding of the disclosure, the accompanying drawings are not shown according to the actual scale, but the dimensions of some components may be exaggerated. The same reference numeral may be given to the same component in different embodiments.

The statement that two comparison targets are ‘the same’ as each other may mean that they are ‘substantially the same’ as each other. Thus, a case where they are ‘substantially the same’ as each other may include a case where they have a deviation regarded as a low level, e.g., a deviation of 5% or less. If a uniform parameter is uniform in a predetermined area, it may mean that it is uniform from an average point of view.

Although first, second, etc., may be used to describe various components, these components are not limited by these terms. These terms are only used to distinguish one component from other components, and unless specifically stated to the contrary, a first component may be a second component.

Throughout the specification, unless specially stated to the contrary, each component may be singular or plural.

If a component is arranged on “a top portion (or a bottom portion)” of another component or “on (or under)” the other component, it may mean not only a case where the component is arranged adjacent to a top surface (or a bottom surface) of the other component, but also a case where another component may be interposed between the other component and the component arranged on (or under) the other component.

If a component is described as being “connected”, “coupled”, or “connected” to another component, it should be understood that the components are directly connected or connectable to each other, but another component may be “interposed” between the components, or the components may be may be “connected”, “coupled”, or “connected” to each other through another component.

Throughout the specification, “A and/or B” may mean A, B, or A and B unless specially stated otherwise. That is, “and/or” may include all or any combination of a plurality of items listed. “C to D” may mean at least C but not more than D, unless specially stated otherwise.

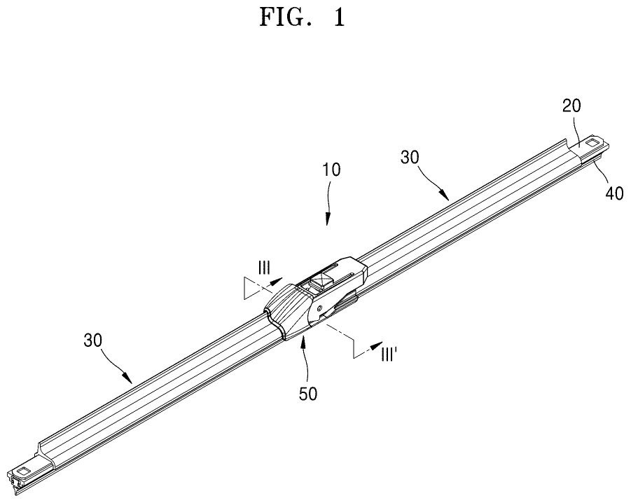

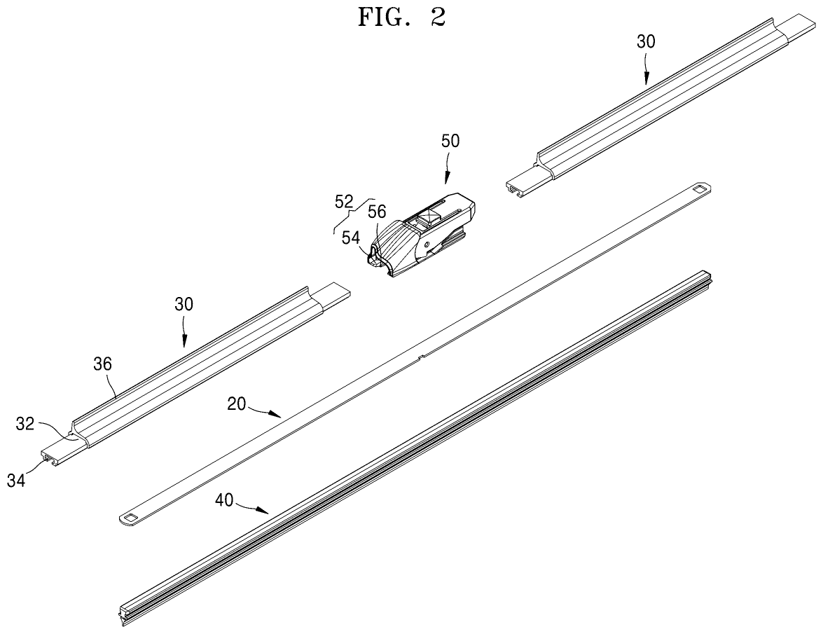

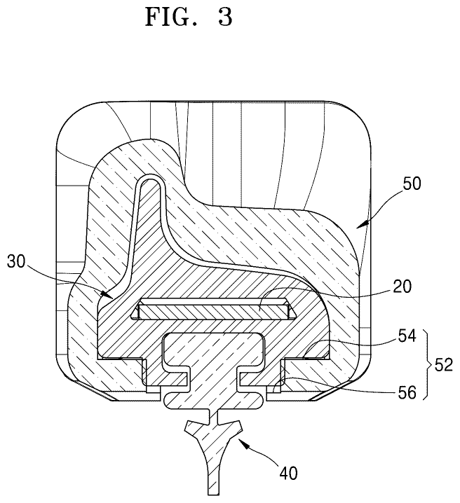

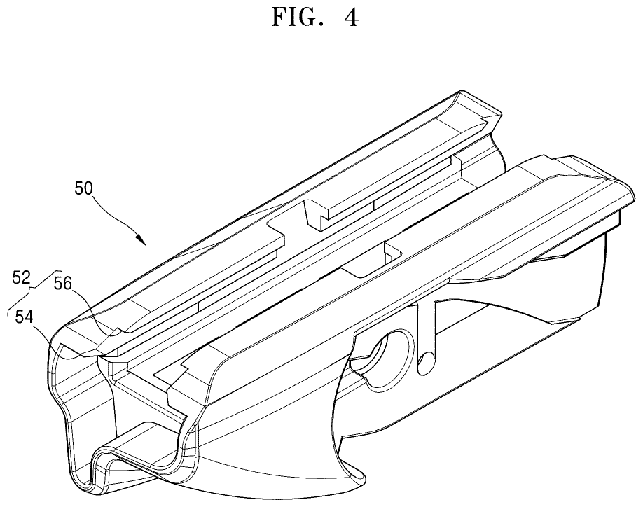

FIG. 1 is a perspective view of a wiper blade device according to an embodiment. FIG. 2 is an exploded perspective view of the wiper blade device shown in FIG. 1. FIG. 3 is a cross-sectional view of the battery module taken along a line III-III shown in FIG. 1; FIG. 4 is a view showing in detail a lower structure of a connector shown in FIG. 2.

Referring to FIGS. 1 to 4, a wiper blade device 10 (hereinafter, referred to as a “wiper blade device”) with an improved structure for preventing separation of a spoiler according to the disclosure may include a support member 20, a spoiler member 30, a wiper lip 40, and a connector 50.

The support member (vertebra) 20 may include metal. The support member 20 may include, for example, stainless steel or carbon steel. The support member 20 may be formed by processing plate-shaped metal into a long rod shape. The support member 20 may be employed to provide an elastic restoring force to the wiper lip 40 described later. The support member 20 may have different curvatures every specific sections to follow a curvature of the glass of the vehicle. For example, the support member 20 may have different curvatures every 0.1 mm sections. The support member 20 may be slidably coupled to the spoiler member 30 described later.

The spoiler member 30 may include synthetic resin. The spoiler member 30 may perform several functions in the flat wiper blade device. The spoiler member 30 may accommodate the support member 20. The spoiler member 30 may include a tunnel-shaped support member accommodating portion 32 to which the support member 20 is coupled. The support member accommodating portion 32 may be a hole penetrated in a longitudinal direction of the spoiler member 30.

The spoiler member 30 may include a wiper lip accommodating portion 34. The wiper lip accommodating portion 34 may be provided on a bottom portion of the spoiler member 30. The wiper lip accommodating portion 34 may have the form of a groove portion that is open downward. The wiper lip 40 may be slidably coupled to the wiper lip accommodating portion 34.

The spoiler member 30 may include a spoiler portion 36. The spoiler portion 36 may be formed on a top portion of the spoiler member 30. It is preferable that the spoiler portion 36 be shaped to generate pressure downwardly from the spoiler member 30 by the flow of air.

A pair of spoiler members 30 may be provided. The spoiler member 30 may be arranged on opposite sides with respect to the center of the connector 50 described below.

The wiper lip 40 may include a material such as rubber. The wiper lip 40 may be coupled to the wiper lip accommodating portion 34. The wiper lip 40 may be coupled to the wiper lip accommodating portion 34 through a sliding structure. The wiper lip 40 remove foreign substances in contact with the vehicle's glass A top portion of the wiper lip 40 may be coupled to the wiper lip accommodating portion 34, and a bottom portion of the wiper lip 40 may protrude from a bottom end of the spoiler member 30.

The connector 50 may be disposed on a central portion of the support member 20. The connector 50 may be fixed on the spoiler member 30. The connector 50 may be coupled to a wiper arm (not shown).

The connector 50 may include a spoiler fixing portion 52 in the form of a groove open downward to enable coupling of the spoiler member 30. The connector 50 may be formed by coupling of a plurality of members. The spoiler fixing portion 52 may be formed in the form of a groove open downward. The spoiler fixing portion 52 may include a first claw 54 and a second claw 56 that support the spoiler member 30 in a height direction of the wiper lip 40 to prevent the spoiler member 30 from being separated downward from the connector. The first claw 54 may be formed on opposite sides with the spoiler member 30 therebetween. The second claw 56 may also be formed on opposite sides with the spoiler member 30 therebetween.

The second claw 56 may be disposed under the first claw 54 in the height direction of the wiper lip 40.

The first claw 54 may be a catching protrusion in a step form to support the spoiler member 30 in the height direction of the spoiler member 30.

The second claw 56 may be a structure in the form of a cantilever protruding toward the wiper lip 40 from the connector 50. The first claw 54 and the second claw 56 may extend in directions parallel to each other.

The second claw 56 may be configured not to contact the wiper lip 40. For example, a space between the second claw 56 and the wiper lip 40 may be about 0.1 mm to about 5 mm.

The second claw 56 may be configured to support the spoiler member 30 closer to a center of the wiper lip 40 in a width direction than the first claw 54. More specifically, the second claw 56 may be positioned more inward from the first claw 54 in the width direction of the wiper lip 40.

The second claw 56 may be formed to have a smaller area in contact with the spoiler member 30 than the first claw 54. The first claw 54 may perform the majority of the role of fixing the spoiler member 30 to the connector 50. The second claw 56 may serve as a safe structure for preventing separation of the spoiler member 30 when an unexpected force is applied to the spoiler member 30 in the height direction of the wiper lip 40.

The second claw 56 may form the lowermost portion of the connector 50. The second claw 56 may protrude inwardly from the lowermost portion of the connector 50 in a horizontal direction.

The spoiler member 30 may not include the spoiler portion 36 in a region coupled to the connector 50.

A cover (not shown) may be installed on an outer end portion of the spoiler member 30 in the longitudinal direction thereof. The cover may serve to enhance the appearance of the wiper blade device 10 and prevent the wiper lip 40 from being separated in the longitudinal direction of the spoiler member 30.

Hereinbelow, an assembly process of the wiper blade device 10 including the above-described components will be described and working effects will be described in detail.

First, the spoiler member 30 may be slidably coupled to the connector 50. Each spoiler member 30 may be coupled to opposite sides of the connector 50. In this state, the support member 20 may be slidably coupled to the support member accommodating portion 32 from the outer end portion of the spoiler member 30. The wiper lip 40 may be slidably coupled to the wiper lip accommodating portion 34 from the outer end portion of the spoiler member 30. When there is a cover, the cover may be coupled to the outer end portion of the spoiler member 30. Through such a process, assembly of the wiper blade device 10 may be completed. The wiper blade device 10 assembled in this way may be installed on the vehicle through coupling between the connector 50 and the wiper arm (not shown).

The wiper blade device 10 assembled in this way may remove foreign substances on the glass of the vehicle through reciprocating rotation of the wiper arm. When an external force is unexpectedly applied to the spoiler member 30 or the connector 50 in this process, the spoiler member 30 may be primarily prevented from being separated from the connector 50 by the first claw 54. The spoiler member 30 may be secondarily prevented from being separated from the connector 50 by the second claw 56. The first claw 54 and the second claw 56 may cooperate with each other to effectively prevent the spoiler member 30 from being separated from the connector 50 even when a large external force is applied.

As such, the wiper blade device having the improved structure for preventing separation of the spoiler may prevent the spoiler member from being easily separated from the connector by an unexpected external force by including the first claw and the second claw in the connector fixing the spoiler member.

While the disclosure is described by limited embodiments and drawings, the disclosure is not limited thereby and various modifications and changes may be made by those of ordinary skill in the art within the technical spirit of the disclosure and the equivalent range to the claims set forth below.

The wiper blade device having the improved structure for preventing separation of the spoiler may prevent the spoiler member from being easily separated from the connector by an unexpected external force by including the first claw and the second claw in the connector fixing the spoiler member.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A wiper blade device having an improved structure for preventing separation of a spoiler, the wiper blade device comprising:
a support member formed longitudinally in a form of a metal-plate shaped rod;
a spoiler member comprising a support member accommodating portion, a wiper lip accommodating portion at a bottom portion thereof, and a spoiler portion at a top end portion thereof, wherein the support member accommodating portion is shaped as a tunnel to which the support member is coupled, the wiper lip accommodating portion has a wiper lip slidably coupled thereto, and a spoiler portion configured to generate pressure downwardly by flow of air;
a wiper lip which is coupled to the wiper lip accommodating portion and comes into contact with glass of a vehicle to remove foreign substances; and
a connector disposed on a central portion of the support member, fixed to the spoiler member, and coupled to a wiper arm,
wherein the connector comprises a spoiler fixing portion in a form of a groove open downward to enable coupling of the spoiler member,
the spoiler fixing portion comprises a first claw and a second claw that support the spoiler member in a height direction of the wiper lip to prevent the spoiler member from being separated downward from the connector,
the second claw is disposed under the first claw in a height direction of the wiper lip, and
the second claw supports the spoiler member closer to a center of the wiper lip than the first claw.

2. The wiper blade device of claim 1, wherein the second claw comprises a structure in a shape of a cantilever protruding from the connector toward the wiper lip.

3. The wiper blade device of claim 2, wherein the second claw is configured to not come into contact with the wiper lip.

4. The wiper blade device of claim 1, wherein the second claw has a smaller area in contact with the spoiler member than the first claw.

5. The wiper blade device of claim 1, wherein the second claw forms a lowermost portion of the connector.

6. The wiper blade device of claim 1, wherein the spoiler member does not comprise the spoiler portion in a region coupled to the connector.
